(19) United States
(12) Patent Application Publication
(10) Pub. No.: US 2010/0243677 A1
(43) Pub. Date: Sep. 30, 2010

(54) COSMETIC CASE FOR EYE CREAM HAVING AIRLESS PUMP

(75) Inventor: Jun-Kuk Lim, Gyeonggi-do (KR)

Correspondence Address: LEVINE & MANDELBAUM, 222 Bloomingdale Road, Suite 203, WHITE PLAINS, NY, 10605, US

(73) Assignee: TOLY KOREA, INC., Gyeonggi-do (KR)

(21) Appl. No.: 12/723,076

(22) Filed: Mar. 12, 2010

(30) Foreign Application Priority Data
Mar. 31, 2009 (KR) 20-2009-0003680

(51) Int. Cl. G01F 11/00

(52) U.S. Cl. 222/256; 222/383.1

(57) ABSTRACT

The invention is a cosmetic case for eye cream having an airless pump, and more particularly, to a cosmetic case for eye cream having an airless pump wherein a semi-sphere tip is provided on a nozzle so as to enable a user to directly apply the cosmetics on a face without using a hand or cosmetic tool, an airless pump, which is pushed from a side, is provided at an upper part, so that the air or foreign substance is basically prevented from being introduced from the outside during the non-use of the cosmetics and the cosmetics are thus prevented from being contaminated and deteriorated and the cosmetics are discharged in a constant amount all the time by operating the pump during the use of the cosmetics, thereby enabling the contents to be used conveniently and efficiently.

The cosmetic case for eye cream having an airless pump comprises: a cylindrical storage case having therein a storage space 11 storing eye cream cosmetics and having a push plate 12 mounted therein; an airtight cap 20 engaged at an upper part of the storage case 10 and having a discharge passage 21; an airless pump 30 that is engaged at an upper part of the airtight cap 20 by a cover 31 and is mounted with a body 33 having a pumping chamber 32, an inlet 34 having a suction valve 38 and a discharge port 35 having a discharge valve 39 being formed at upper and lower parts of the body 33, respectively, an operation button 37 elastically mounted in the pumping chamber 32 by a spring 36 being mounted at a side of the body with a part thereof being exposed to the outside, the airless pump pumping the contents by a push operation of the operation button; a nozzle pipe 40 that is mounted to extend by a predetermined length at an upper part of the cover 31 and has a convex inclined tip 42 at an end nozzle 41; and a lid 50 that opens and closes an upper part of the storage case 10.

### CROSS-REFERENCE TO RELATED APPLICATIONS

This application claims all benefits of Korean Patent Application No. 20-2009-0003680 filed on Mar. 31, 2009 in the Korean Intellectual Property Office, the disclosures of which are incorporated herein by reference.

### BACKGROUND OF THE INVENTION

1. Field of the Invention

The invention is a cosmetic case for eye cream having an airless pump, and more particularly, to a cosmetic case for eye cream having an airless pump wherein a semi-sphere tip is provided on a nozzle so as to enable a user to directly apply the cosmetics on a face without using a hand or cosmetic tool, an airless pump, which is pushed from a side, is provided at an upper part, so that the air or foreign substance is basically prevented from being introduced from the outside during the non-use of the cosmetics and the cosmetics are thus prevented from being contaminated and deteriorated and the cosmetics are discharged in a constant amount all the time by operating the pump during the use of the cosmetics, thereby enabling the contents to be used conveniently and efficiently.

2. Description of the Prior Art

In general, a person has moles, freckles, blemishes, dark spots and the like on the face. As the person grows older, functions of the skin are depressed due to inner and outer causes of the body, such as dryness of the skin, wrinkles and the like. Particularly, some people have dark circles around both eyes.

Like this, in order to prevent the various phenomena occurring on the face skin or to cover or remove the phenomena that have already occurred, a variety of medical treatments are performed and a variety of functional cosmetics are used.

Among them, the functional cosmetics for covering the dark circles occurring around the eyes so that they are unseen are called as eye cream cosmetics. The eye cream cosmetics have not only functions of caring and covering the dark circles but also additional functions of moisturizing and whitening the corners of the eyes, removing the wrinkles at the corners of the eyes, removing wastes of the horny layer of the corners of the eyes and the like.

In addition, the functional cosmetics are also widely used which have effects of moisturizing and whitening the whole face, removing the wrinkles at the whole face, removing wastes of the horny layer of the whole face and the like as well as the specific parts such as corners of the eyes.

Generally, the cosmetics such as eye cream are applied with a hand or various cosmetic tools. However, an unsanitary problem is caused and it is not easy to efficiently apply the cosmetics to a specific part.

In addition, the conventional cosmetic case for eye cream is opened and closed with a cover. Thus, when using or not using the cosmetics, the outside air or foreign substance is introduced through a nozzle, so that the cosmetics are easily contaminated and deteriorated. Even when the cosmetics are not contaminated and deteriorated, the inherent scent and smell and moisture of the cosmetics easily come off, so that the inherent ingredients of the cosmetics are lost.

In addition to the above problems, when using the cosmetics, it is difficult to accurately discharge the cosmetics in the cosmetic case by a necessary proper amount. In other words, since it is required to discharge and use the cosmetics by a user's sense, the cosmetics may be wasted.

Accordingly, considering the above structure problems, a structure is suggested in which a separate tip is formed around a nozzle through which the cosmetics are discharged, so that a user can directly apply the cosmetics to the skin using the tip without using a hand.

However, according to the above structure, the tip is formed around the nozzle, so that the outside air or foreign substance is introduced through the nozzle even when the user does not use a hand. In addition, it is not possible to accurately control the discharge amount of the cosmetics.

### SUMMARY OF THE INVENTION

Accordingly, the present invention has been made to solve the above problems occurring in the prior art.

An object of the invention is to provide a cosmetic case for eye cream having an airless pump suitable for the case storing the eye cream cosmetics.

Another object of the invention is to provide a cosmetic case for eye cream wherein an airless pump is provided to the cosmetic case to block the outside air or foreign substance from being introduced and thus to prevent the cosmetics from being contaminated and deteriorated and, when using the cosmetics, the pump is operated to accurately discharge the cosmetics by a constant amount, thereby improving the convenience of use and reducing wastes of the cosmetics.

In order to achieve the above objects, there is provided a cosmetic case for eye cream having an airless pump mounted to horizontally operate. The cosmetic case comprises a cylindrical storage case capable of storing eye cream cosmetics therein, an airtight cap engaged at an upper part of the storage case, an airless pump that is horizontally mounted at an upper part of the airtight cap by a cover and has an operation button exposed to the outside, and a nozzle pipe that is mounted to extend by a predetermined length at an upper part of the cover and has a convex tip at an end nozzle. According to the cosmetic case, the outside air and foreign substance is blocked from being introduced, the airless pump is operated to accurately discharge the contents by a constant amount and the cosmetics discharged from the nozzle can be directly applied to the skin through the tip.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a cosmetic case to which the invention is applied;

FIG. 2 is a side view of a cosmetic case according to an embodiment of the invention, in which a cover is omitted;

FIG. 3 is a sectional view of a cosmetic case according to an embodiment of the invention;

FIG. 4 is a side sectional view of a principal part of FIG. 3; and

FIGS. 5 and 6 are sectional views showing operating states of a cosmetic case according to an embodiment of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

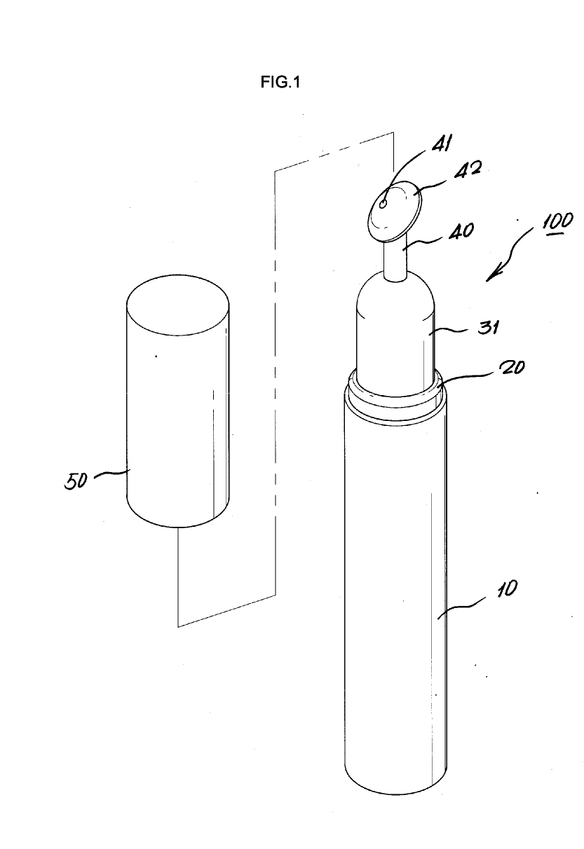

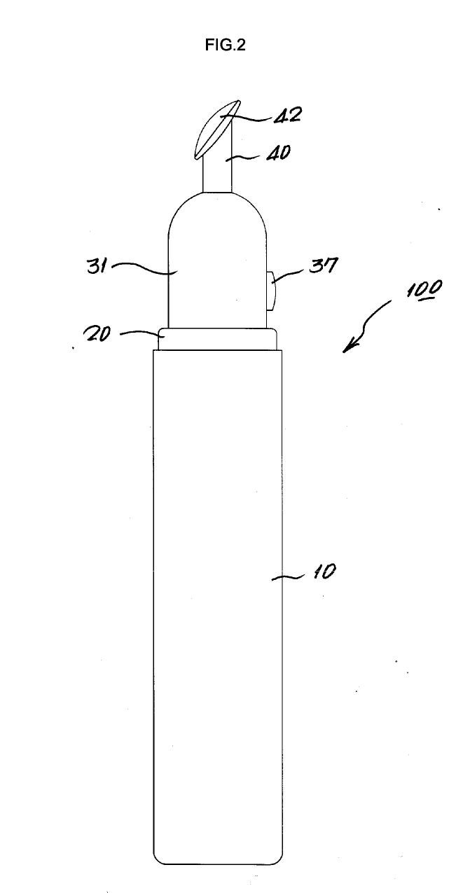

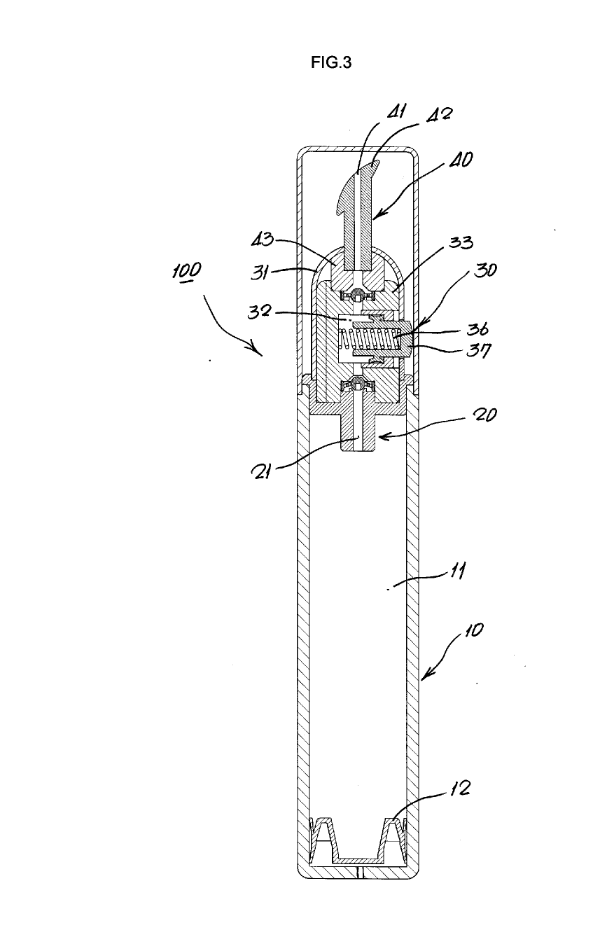

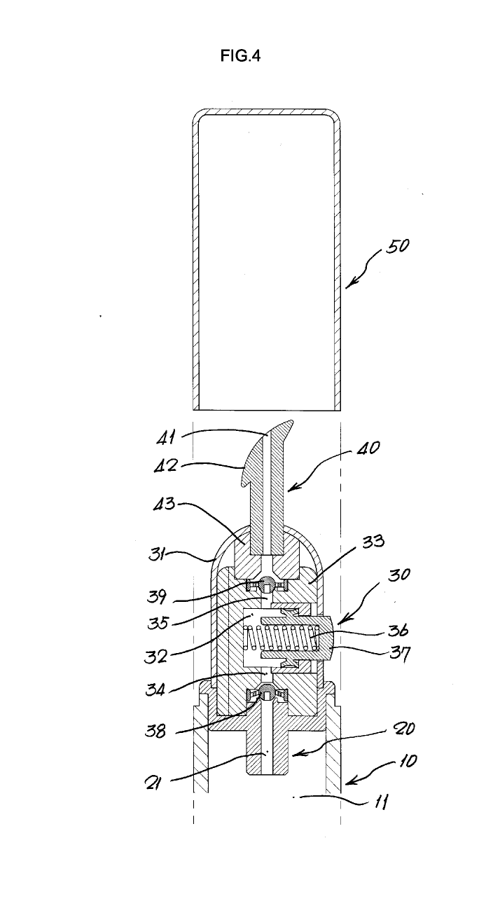

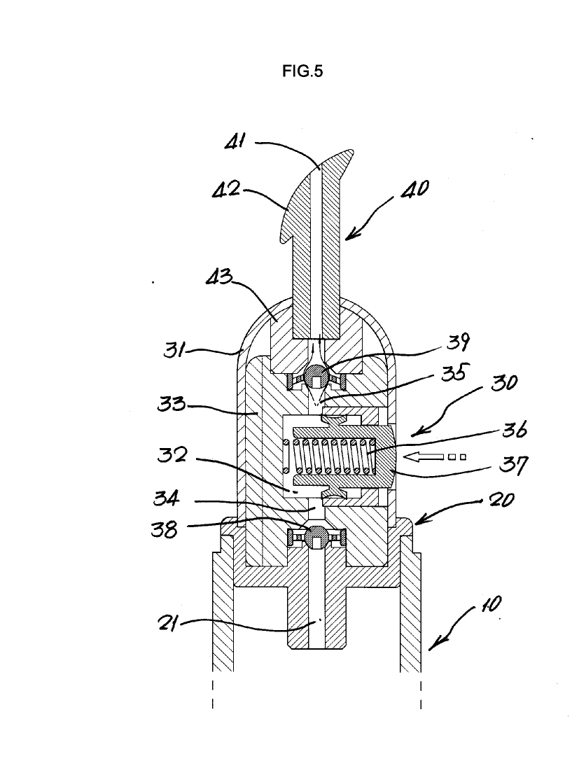

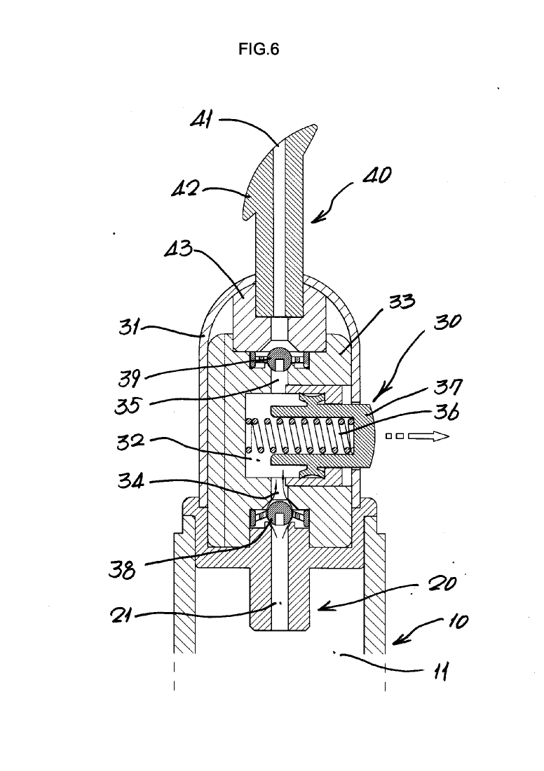

FIGS. 1 to 3 show an overall structure of the invention in details, FIG. 4 specifically shows a pump structure of the invention, and FIGS. 5 and 6 show operating states of the invention in details.

A reference numeral 100 indicates a main body of a cosmetic case for eye cream according to an embodiment of the invention, which comprises a cylindrical storage case 10 storing eye cream cosmetics therein, an airtight cap 20 engaged at an upper opening of the storage case 10, an airless pump 30 that is engaged at an upper part of the airtight cap 20 by a cover 31 and pumps the contents by a pushing operation, a nozzle pipe 40 that is mounted to extend by a predetermined length at an upper part of the cover 31 and has a tip at an end, and a lid 50 that opens and closes the upper part of the storage case 10.

To be more specific, the storage case 10 is formed into a cylindrical shape having a storage space 11 capable of storing eye cream of a gel state and has therein a push plate 12 that pushes up the contents by vacuum pressure and at a bottom face an air passage hole 13 enabling the push plate 12 to smoothly operate.

In addition, the airtight cap 20 is engaged at the opening of the storage case 10 to seal it and is formed with a discharge passage 21 that communicates with the storage case 10 and through which the contents are discharged.

Further, the airless pump 30 is mounted to the upper part of the airtight cap 20 by the dome-shaped cover 31.

The airless pump 30 is mounted with a body 33 having a pumping chamber 32 in the cover 31. Upper and lower parts of the body 33 are formed with an inlet 34 and a discharge port 35 communicating with the pumping chamber 32, respectively. A side of the body is mounted with an operation button 37 having a piston function that is elastically mounted in the pumping chamber 32 by a spring 36 and performs compression.

The inlet 34 is connected to the discharge passage 21 of the airtight cap 20 at the lower part of the body 33 and enables the contents from the storage case 10 to flow in the pumping chamber 32. A separate suction valve 38 is mounted on the inlet 34.

The suction valve 38 is a check valve that enables the contents stored in the storage case 10 to flow in the pumping chamber 32 and blocks the contents from flowing in a reverse direction.

In addition, the discharge port 35 is formed at the upper part of the body 33 and a separate discharge valve 39 is mounted on the discharge port 35. The discharge valve 39 has a structure reverse to the suction valve 38, i.e., enables the contents pumped from the pumping chamber 32 to be discharged and blocks the contents from being introduced in a reverse direction.

The operation button 37 is elastically mounted in the pumping chamber 32 in a horizontal direction by the spring 36. A part of the operation button is exposed to the outside of the cover 31, so that it is advanced and retreated by a push operation of a user and elastic force of the spring 36, thereby compressing the inside of the pumping chamber 32 to provide pumping force.

In other words, as the exposed part of the operation button 37 is pushed, the spring 36 is compressed to compress the inside of the pumping chamber 32, so that the contents in the storage case 10 are pumped and discharged through the upper nozzle.

In addition, the nozzle pipe 40 for discharging the contents pumped by the airless pump 30 to the outside is mounted at the upper part of the cover 39 to vertically extend. The nozzle pipe is formed into a pipe shape and has at its upper end a convex tip 42 having a nozzle 41.

The nozzle pipe 40 is mounted at the upper discharge port 35 of the body 33 by an assembly member 43, and the discharge valve 39 is mounted between the assembly member and the discharge port and is opened and closed depending on the pumping operations.

Furthermore, the nozzle pipe 40 is long formed to extend somewhat, thereby improving the convenience of use. The tip 42 at the end thereof is formed to be inclined and to have a concave curved surface. Thus, the tip provides a partial massage function and a function of easily applying the cosmetics when the tip is contacted to the skin.

Thus, according to the invention structured as described above, the inside of the storage space 11 of the storage case 10 is maintained to be airtight by the airtight cap 20 while the eye cream is filled in the storage space and the airless pump 30 and the nozzle pipe 40 are assembled by the cover 31 at the upper part of the airtight cap 20, which are opened and closed by the lid 50.

According to the cosmetic case 100 of the invention, during the non-use of the cosmetics, the suction valve 38 and the discharge valve 39 block the discharge passage of the cosmetics and the operation button 37 is also retreated by the elastic force of the spring 36. Thus, the eye cream cosmetics stored in the storage space 11 in the storage case 10 can be safely kept for a long time.

Under such state, when using the cosmetics, a user opens the lid 50, contacts the tip 42 of the nozzle pipe 40 on the skin and pushes the operation button 37 of the airless pump 30. Thereby, the operation button 37 is advanced while compressing the spring 36, thereby compressing the pumping chamber 32.

Then, the pressure is applied to the pumping chamber 32, so that the suction valve 38 is closed and the discharge valve 39 is opened. Thereby, the cosmetics remaining in the pumping chamber 32 are discharged to the nozzle 41 of the nozzle pipe 40 through the discharge port 35.

Like this, the cosmetics are discharged to the nozzle 41 located at the center of the tip 42. Thus, just by rubbing the tip 42 on the skin, it is possible to apply the cosmetics to the skin sanitarily, stably and conveniently.

The cosmetics, which are discharged as described above, are discharged in a constant amount only by one pushing operation of the operation button 37. When the pushed operation button 37 is released, the operation button 37 is retreated to return to its original position by the elastic force of the compressed spring 36.

Thereby, the vacuum pressure prevails in the pumping chamber 32, so that the suction valve 38 opens the inlet 34 and the discharge valve 39 closes the discharge port 35. As a result, the cosmetics in the storage case 10 is introduced into the pumping chamber 32 through the inlet 34 via the discharge passage 21 of the airtight cap 20 and stands by for next operation.

By repeating the above operations, it is possible to directly apply the cosmetics, which are discharged through the nozzle 41, to the skin through the tip 42 conveniently and stably and to use the cosmetics of a necessary amount only without waste.

As described above, according to the invention, the nozzle pipe through which the cosmetics are discharged is formed to extend by a predetermined length and is provided at its end nozzle with the curved tip. Thus, it is possible to directly apply the cosmetics to the skin without using a hand or other cosmetic tools, so that it is possible to apply the cosmetics in a very sanitary manner while partially providing a massage function.

In addition, the airless pump is horizontally mounted to the cosmetic case for eye cream, thereby improving the convenience of use. Further, it is possible to basically block the outside air and foreign substance from being introduced and to prevent the scent or moisture of the cosmetics from being diffused. Thus, it is possible to prevent the cosmetics from being contaminated and deteriorated and the functions of the cosmetics from being lowered.

Furthermore, when using the cosmetics in the cosmetic case for eye cream, the contents are discharged in a constant amount all the time by the pumping operation of the airless pump, so that it is possible to improve the convenience of use and to reduce the wastes.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A cosmetic case for eye cream having an airless pump, comprising:
a cylindrical storage case having therein a storage space storing eye cream cosmetics and having a push plate mounted therein;
an airtight cap engaged at an upper part of the storage case and having a discharge passage;
an airless pump that is engaged at an upper part of the airtight cap by a cover and is mounted with a body having a pumping chamber, an inlet having a suction valve and a discharge port having a discharge valve being formed at upper and lower parts of the body, respectively, an operation button elastically mounted in the pumping chamber by a spring being mounted at a side of the body with a part thereof being exposed to the outside, the airless pump pumping the contents by a push operation of the operation button;
a nozzle pipe that is mounted to extend by a predetermined length at an upper part of the cover and has a convex inclined tip at an end nozzle; and
a lid that opens and closes an upper part of the storage case.
